(19) United States
(12) Patent Application Publication
(10) Pub. No.: US 2014/0078989 A1
(43) Pub. Date: Mar. 20, 2014

(54) METHOD AND APPARATUS FOR IMPROVING INTER-eNB CARRIER AGGREGATION IN A WIRELESS COMMUNICATION SYSTEM

(71) Applicant: INNOVATIVE SONIC CORPORATION, Taipei City (TW)

(72) Inventors: Yu-Hsuan Guo, Taipei City (TW); Meng-Hui Ou, Taipei City (TW)

(73) Assignee: INNOVATIVE SONIC CORPORATION, Taipei City (TW)

(21) Appl. No.: 14/030,090

(22) Filed: Sep. 18, 2013

Related U.S. Application Data
(60) Provisional application No. 61/702,892, filed on Sep. 19, 2012.

(51) Int. Cl. H04W 72/04

(52) U.S. Cl. CPC H04W 72/0426
USPC 370/329

(57) ABSTRACT

A method and apparatus are disclosed for operating a wireless communication system by receiving a request message transmitted from a first network node to a second network node to request Carrier Aggregation to aggregate a cell controlled by the second network node to a User Equipment (UE), the request message including a Radio Network Temporary Identifier (RNTI) of a UE, and transmitting an accept message or a reject message from the second network node to the first network node to indicate whether to accept or reject Carrier Aggregation.

### CROSS-REFERENCE TO RELATED APPLICATIONS

The present application claims the benefit of U.S. Provisional Patent Application Ser. No. 61/702,892 filed on Sep. 19, 2012, the entire disclosure of which is incorporated herein by reference.

### FIELD

This disclosure generally relates to wireless communication networks, and more particularly, to a method and apparatus for improving Inter-eNB carrier aggregation in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for operating a wireless communication system by receiving a request message transmitted from a first network node to a second network node to request Carrier Aggregation to aggregate a cell controlled by the second network node to a UE, the request message including a Radio Network Temporary Identifier (RNTI) of a User Equipment (UE), and transmitting an accept message or a reject message from the second network node to the first network node to indicate whether to accept or reject Carrier Aggregation

A method and apparatus are disclosed for operating a wireless communication system by transmitting a message from a second network node to a first network node and indicating with the message that one or more available values of a Radio Network Temporary Identifier (RNTI) corresponding to a cell controlled by the second network node.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram of different frequency layers in a wireless communication system.

FIG. 6 is a diagram of architecture of Inter-eNB Carrier Aggregation.

FIG. 7 is a diagram showing UpLink (UL) control signaling in Drift eNB.

FIG. 8 is a message sequence chart according to one embodiment.

FIG. 9 is a message sequence chart according to one embodiment.

FIG. 10 is a message sequence chart according to one embodiment.

FIG. 11 is a flow chart according to one exemplary embodiment.

FIG. 12 is a flow chart according to one exemplary embodiment.

FIG. 13 is a functional block diagram of two network nodes in a communication system according to one embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including document RWS-120046, “Technologies for Rel-12 and onwards”; 3GPP TS 36.300 V11.2.0, “E-UTRA and E-UTRAN; Overall description; Stage 2” (hereinafter referred to as 3GPP TS 36.300); and 3GPP TS 36.331 V11.0.0, “E-UTRA RRC protocol specification (Release 11)” (hereinafter referred to as 3GPP TS 36.331). The standards and documents listed above are hereby expressly incorporated herein.

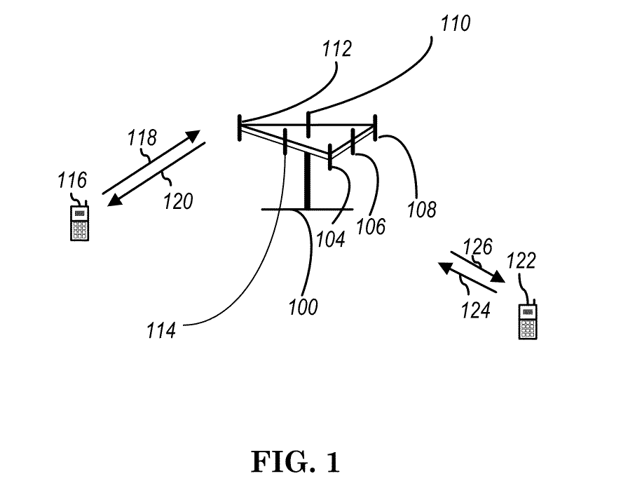

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

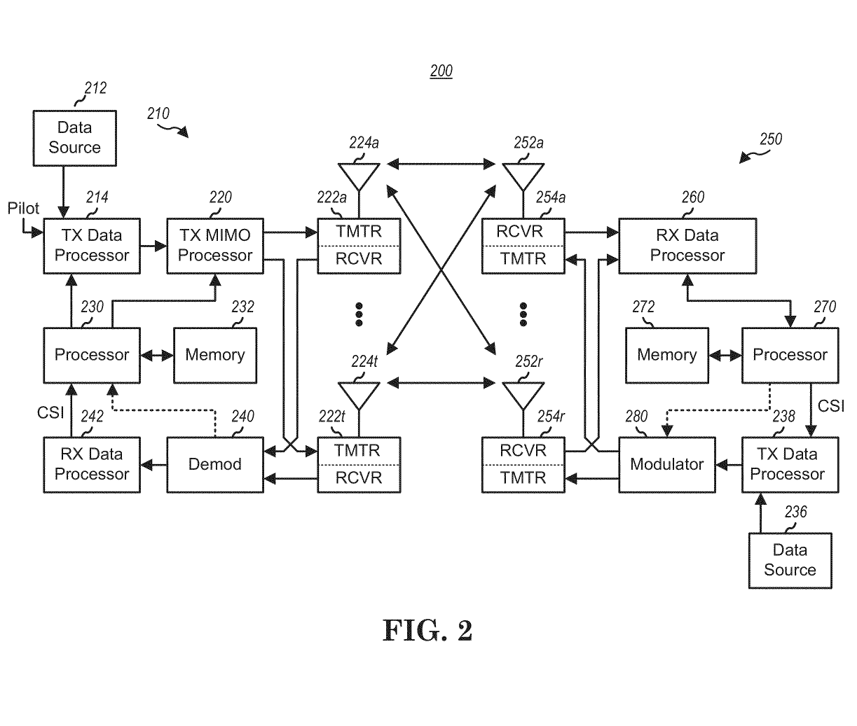

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

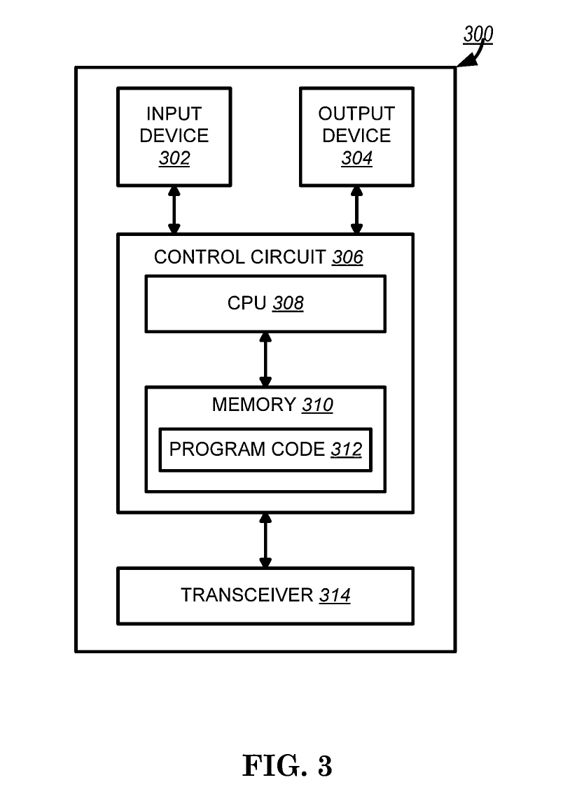

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

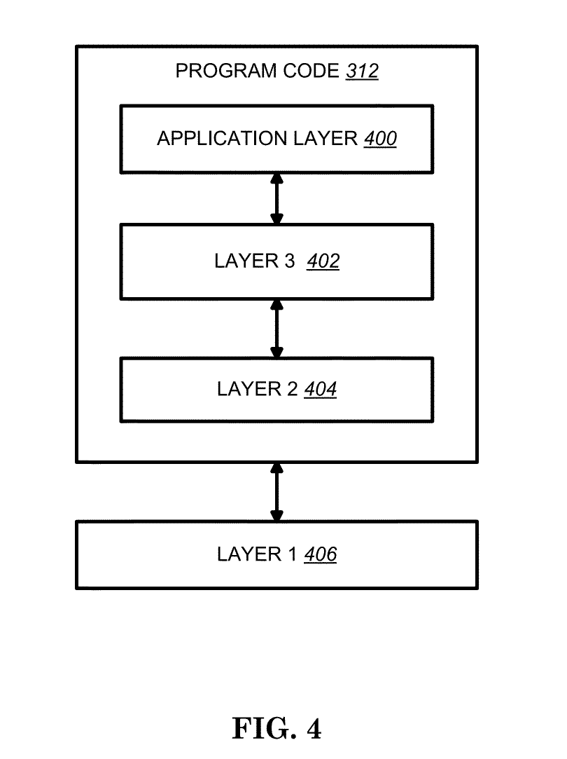

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

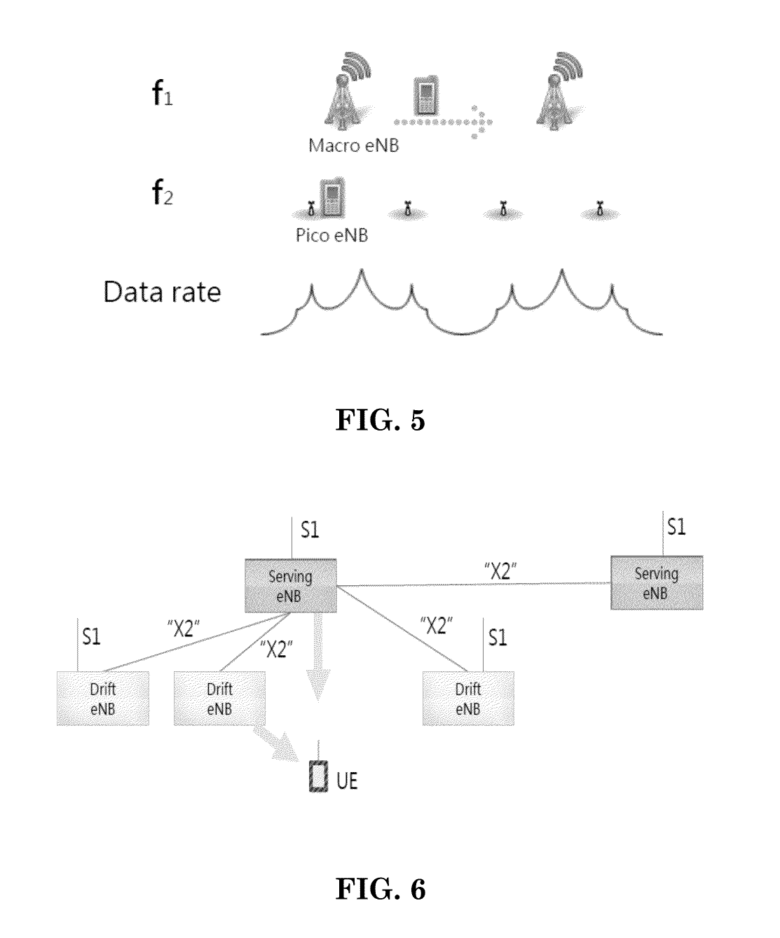

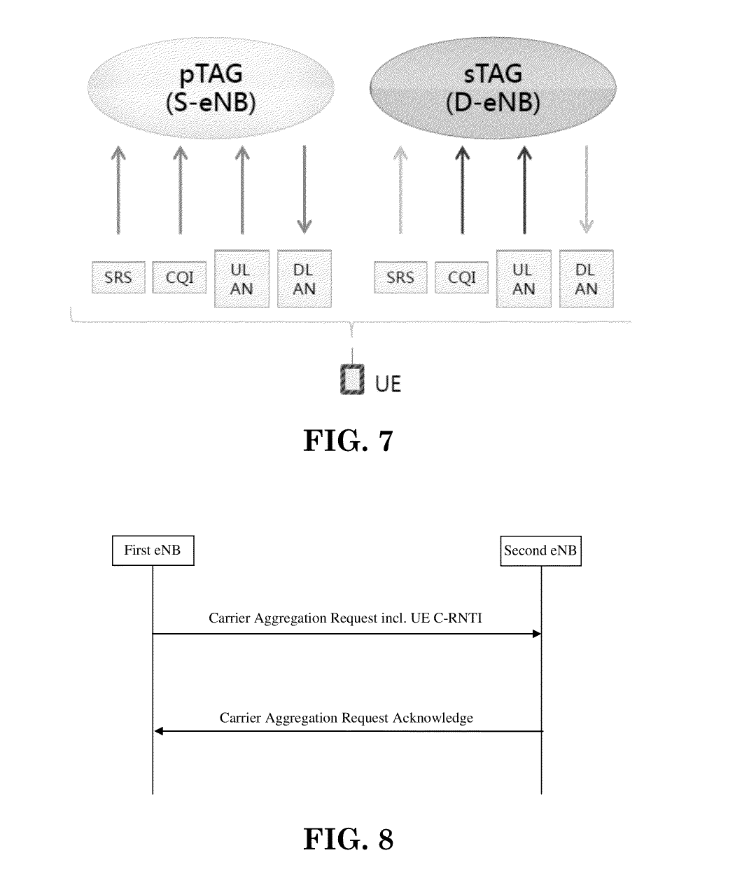

Referring to FIG. 5, fiber based cloud Radio Access Network (RAN) operates by using a Macro-cell layer in frequency 1 for mobility robustness and pico cells in frequency 2 for throughput boost. RWS-120046 proposed Inter-eNB Carrier Aggregation as an alternative to fiber based cloud-RAN. In Inter-eNB Carrier Aggregation as shown in FIG. 6, a Serving eNB controls a Macro-cell and Drift eNB controls pico cells. Furthermore, RWS-120046 raises the following considerations regarding the impact of the proposed architecture of Inter-eNB Carrier Aggregation on the current 3GPP specification: Is traffic splitting (for Serving eNB and Drift eNB) in Core Network (CN) or Drift eNB? If traffic splitting is in RAN, how should user data over “X2” be transported? Is “X2” a new interface or update of existing interface? How Drift eNB UpLink (UL) control information is handled, with an example shown in FIG. 7? And is Random Access Channel Msg2 from Drift eNB?

In LTE release 10 and release 11 Carrier Aggregation, as specified in 3GPP TS 36.300 and 3GPP TS 36.331, one UE has only one Cell Radio Network Temporary Identifier (C-RNTI) which is used to monitor all configured Physical Downlink Control Channels (PDCCH) on all aggregated serving cells including Primary Cell (PCell) and Secondary Cells (SCells). Since LTE release 10 and release 11 only support Intra-eNB Carrier Aggregation, i.e. all aggregated serving cells are controlled by the same eNB, it is easy for an eNB to reserve the same C-RNTI value for a specific UE in multiple cells controlled by the eNB. However, under the scenario of Inter-eNB Carrier Aggregation, there is no guarantee that the original C-RNTI assigned by a first eNB for a UE would not be used by a second eNB for other UE. For example, UE 1 connects to Cell 1 controlled by eNB 1 and is assigned with C-RNTI=123. Then, eNB 1 decides to aggregate Cell 2 controlled by eNB 2 for UE 1. However, C-RNTI=123 in Cell 2 is already used by UE 2 and Carrier Aggregation may fail or C-RNTI of the UE 2 needs to be released, for example by handover. Therefore, coordination between eNBs becomes complex and interactions between eNBs needs to be specified in order to introduce Inter-eNB Carrier Aggregation.

A UE connects to a cell controlled by a first eNB. Before the first eNB configures the UE to aggregate a cell controlled by a second eNB, coordination between the first eNB and the second eNB is required. According to one embodiment, the first eNB provides required information for carrier aggregation to the second eNB. The required information may include a C-RNTI value assigned to the UE in the cell controlled by the first eNB. After receiving the information, the second eNB may accept as shown in FIG. 8, or reject to provide the cell controlled by the second eNB to the UE for Carrier Aggregation.

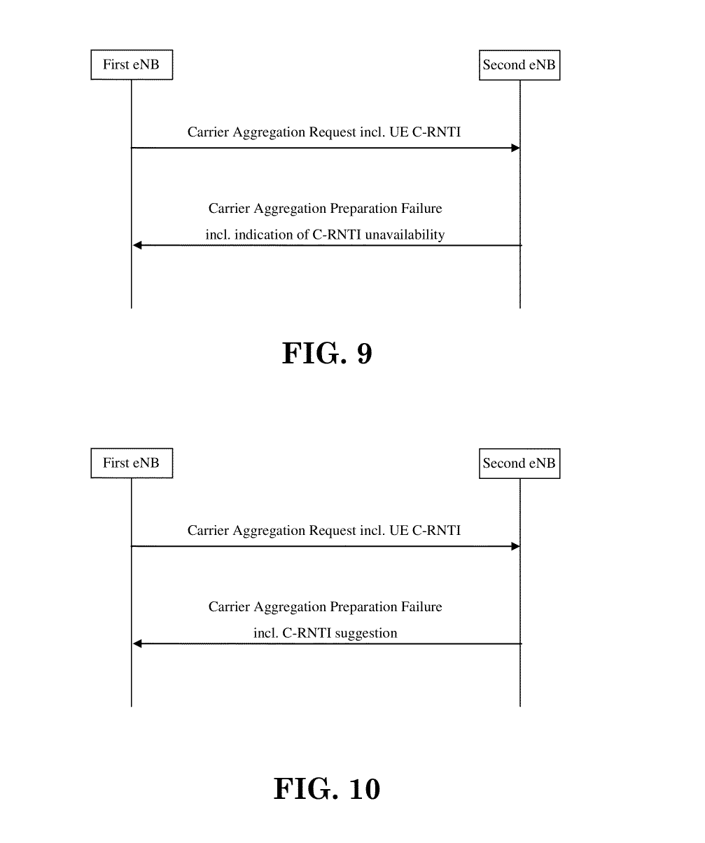

If the second eNB rejects Carrier Aggregation, the second eNB could indicate the cause of the rejection. For example, the cause may be unavailability of the C-RNTI value as shown in FIG. 9. Based on the cause, the first eNB can know whether or not there is possibility the aggregation next time will succeed. For example, if the cause of the rejection is cell congestion, aggregation may not succeed in a period of time. If the cause is unavailability of the C-RNTI value and the first eNB wants to try Carrier Aggregation to aggregate the cell controlled by the second eNB, the first eNB may assign another C-RNTI value to the UE, e.g. by Intra-cell handover.

Alternatively, the second eNB could provide one or more C-RNTI values suggested (or available) in the cell controlled by the second eNB to the first eNB. Referring to the example of FIG. 10, the C-RNTI values could be provided in a specific message or a reject message if the second eNB rejects Carrier Aggregation due to unavailability of the C-RNTI value. If the first eNB wants to try Carrier Aggregation to aggregate the cell controlled by the second eNB, the first eNB may assign another C-RNTI value to the UE based on the suggested (or available) C-RNTI values instead of blindly assigning a C-RNTI value to the UE. More specifically, the assumption is that one UE has only one C-RNTI which is used to monitor all configured PDCCHs on all aggregated serving cells. The above-described methods and/or procedures can also be applied to Transmit Power Control-Physical Uplink Control Channel-RNTI (TPC-PUCCH-RNTI) or Transmit Power Control-Physical Uplink Shared Channel-RNTI (TPC-PUSCH-RNTI).

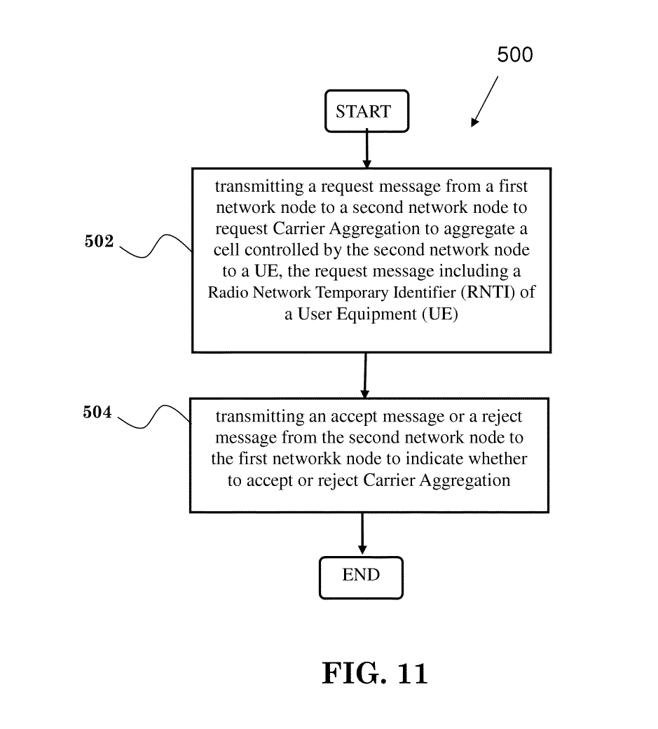

FIG. 11 shows a flowchart for a method 500 of operating a wireless communication system according to one embodiment as described herein. The method 500 includes at 502 receiving a request message transmitted from a first network node to a second network node to request Carrier Aggregation to aggregate a cell controlled by the second network node to a UE and the request message includes a RNTI of the UE. At 504, the method 500 includes transmitting an accept message or a reject message from the second network node to the first network node to indicate whether to accept or reject Carrier Aggregation.

The request message transmitted from the first network to the second network node may be a Carrier Aggregation request message or a Carrier Aggregation preparation message. Further, the request message may include: (1) power saving preference of the UE; (2) interference information of the UE for in device coexistence; (3) location information of the UE, such as position or speed; (4) a cause for Carrier Aggregation; and/or (5) one or more available values for the RNTI, such as a value for the RNTI which is not used by any UE in the cell controlled by the first network node.

The accept message transmitted from the second network node to the first network node may be a Carrier Aggregation request acknowledge message or a Carrier Aggregation preparation acknowledge message. Further, the message may include: (1) an indication of whether the second network node is (mobile) relay; (2) congestion situation in the cell controlled by the second network node; and/or (3) a value for the RNTI, which can be used by the UE in the cell controlled by the second network node. The value for the RNTI may be provided by the request message.

The reject message transmitted from the second network node to the first network node may be a Carrier Aggregation request failure message or a Carrier Aggregation preparation failure message. Further, the message may include: (1) a reject cause set to unavailability of the RNTI if the RNTI is used by another UE in the cell controlled by the second network node; (2) one or more suggested values for the RNTI; (3) one or more available values for the RNTI, such as a value which is not used by any UE in the cell controlled by the second network node; (4) a wait time to prohibit the request message; (5) congestion situation in the cell controlled by the second network node; and/or (6) a reject cause that the second network node is a (mobile) relay.

In one embodiment, the RNTI included in the request message is used by the UE in a cell controlled by the first network node. The second network node does not transmit the accept message if the RNTI is used by another UE in the cell controlled by the second network node. Furthermore, the second network node transmits the reject message if the RNTI is used by another UE in the cell controlled by the second network node. In another embodiment, the accept message and the reject message can use the same message which can indicate acceptation or rejection, such as a Carrier Aggregation response message.

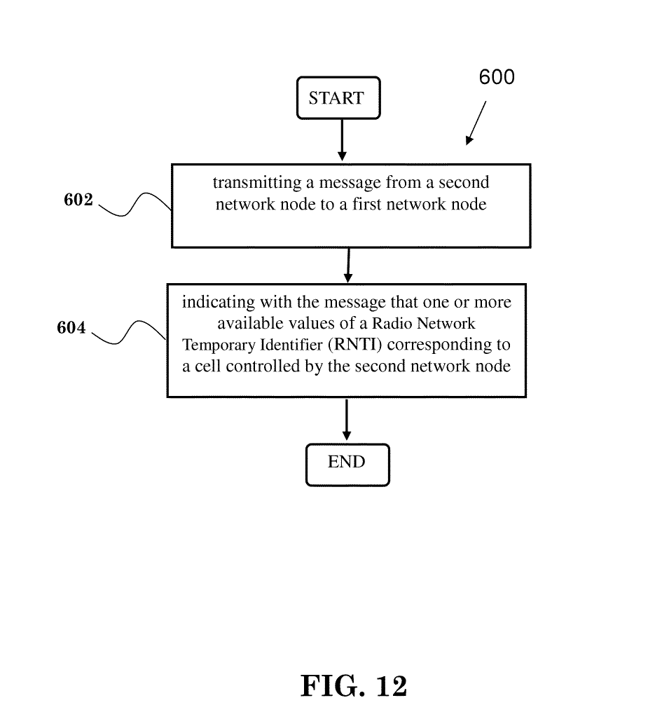

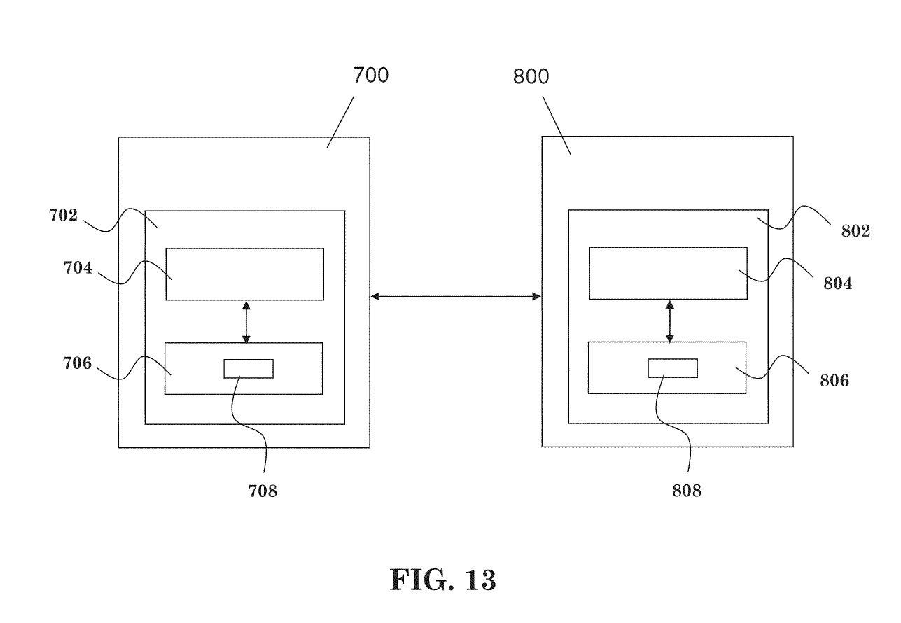

FIG. 12 shows a flowchart for a method 600 of operating a wireless communication system according to another embodiment as described herein. The method 600 includes at 602 transmitting a message from a second network node to a first network node. The method 600 further includes at 604 indicating with the message that one or more available values of a Radio Network Temporary Identifier (RNTI) corresponding to a cell controlled by the second network node. For example, the value is not used by any UE in the cell.

The second network node may transmit the message to the first network node if requested by the first network node and/or if the available RNTI values change compared with the available RNTI values previously transmitted to the first network node. The message may include available values which may correspond to different cells controlled by the first network node.

In the above embodiments, the message mentioned above may be transmitted via a connection between the first network node and the second network node, e.g., X2. The RNTI may be a C-RNTI, a Transmit Power Control-Physical Uplink Control Channel-RNTI (TPC-PUCCH-RNTI) and/or a Transmit Power Control-Physical Uplink Shared Channel-RNTI (TPC-PUSCH-RNTI). The first network node or the second network node may an eNB, a node B and/or a (mobile) relay.

As described above, coordination between eNBs become complex and interactions between eNBs needs to be specified in order to introduce Inter-eNB Carrier Aggregation. When a UE connects to a cell controlled by a first eNB, before the first eNB configures the UE to aggregate a cell controlled by a second eNB, coordination between the first eNB and the second eNB is required. The one or more methods described herein define interactions between eNBs to provide coordination between eNBs to prevent the failure of Inter-eNB Carrier Aggregation.

Referring to FIG. 13, a first network node 700 may include a control circuit 702. The control circuit 702 may include a processor 704 and a memory 706 that is operatively coupled to the processor 704. According to one embodiment, the first network node 700 includes a program code 708 stored in memory 706 that when executed by the processor 704 causes the first network node 700 to transmit a request message from a first network node to a second network node to request Carrier Aggregation to aggregate a cell controlled by the second network node to a UE as described herein and shown at step 502 of FIG. 11. Referring to FIG. 13, the second network node 800 may include a control circuit 802. The control circuit 802 may include a processor 804 and a memory 806 that is operatively coupled to the processor 804. The second network node includes a program code 808 stored in memory 806 that when executed by the processor 804 causes the second network node to transmit an accept message or a reject message from the second network node to the first network node to indicate whether to accept or reject Carrier Aggregation as described herein and shown at step 504 of FIG. 11.

According to another embodiment, the program code 708 when executed by the processor 704 causes the first network node 700 to transmit a message from a second network node to a first network node as described herein and shown at step 602 of FIG. 12. The program code 808 when executed by the processor 804 causes the second network node to indicate with the message that one or more available values of a Radio Network Temporary Identifier (RNTI) corresponding to a cell controlled by the second network node as described herein and shown at step 604 of FIG. 12.

Referring back to FIGS. 3 and 4, in one embodiment, the device 300 implements a UE and includes a program code 312 stored in memory 310. In one embodiment, the CPU 308 could execute the program code 312 to enable the UE to perform any of the actions described herein associated with a UE.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of operating a wireless communication system comprising:
receiving a request message transmitted from a first network node to a second network node to request Carrier Aggregation to aggregate a cell controlled by the second network node to a UE, the request message including a Radio Network Temporary Identifier (RNTI) of a User Equipment (UE); and
transmitting an accept message or a reject message from the second network node to the first network node to indicate whether to accept or reject Carrier Aggregation.

2. The method of claim 1, wherein the request message comprises at least one of:
power saving preference of the UE;
interference information of the UE for in device coexistence;
information related to a location of the UE;
a cause for Carrier Aggregation; or
one or more available values for the RNTI.

3. The method of claim 1, wherein the RNTI is used by the UE in a cell controlled by the first network node.

4. The method of claim 1, wherein the accept message comprises at least one of:
an indication of whether or not the second network node is a mobile relay;
congestion situation in the cell controlled by the second network node; or
a value for the RNTI.

5. The method of claim 1, wherein the RNTI is one of:
a Cell RNTI (C-RNTI);
a Transmit Power Control-Physical Uplink Control Channel RNTI (TPC-PUCCH-RNTI); or
a Transmit Power Control-Physical Uplink Shared Channel-RNTI (TPC-PUSCH-RNTI).

6. The method of claim 1, wherein the reject message comprises at least one of:
a reject cause set to unavailability of the RNTI if the RNTI is used by another UE in the cell controlled by the second network node;
one or more suggested values for the RNTI;
one or more available values for the RNTI;
a wait time to prohibit the request message;
congestion situation in the cell controlled by the second network node; or
a reject cause that the second network node is a (mobile) relay.

7. The method of claim 1, wherein the second network node transmits the reject message if the RNTI is used by another UE in the cell controlled by the second network node.

8. A method of operating a wireless communication system comprising:
transmitting a message from a second network node to a first network node; and
indicating with the message that one or more available values of a Radio Network Temporary Identifier (RNTI) corresponding to a cell controlled by the second network node.

9. The method of claim 8, wherein the second network node transmits the message to the first network node if requested by the first network node or the available values change compared with the available values previously transmitted to the first network node.

10. The method of claim 8, wherein the RNTI is one of:
a Cell RNTI (C-RNTI);
a Transmit Power Control-Physical Uplink Control Channel RNTI (TPC-PUCCH-RNTI); or
a Transmit Power Control-Physical Uplink Shared Channel-RNTI (TPC-PUSCH-RNTI).

11. A communications system comprising:
a second network node comprising a network node control circuit, a network node processor installed in the network node control circuit, and a network node memory installed in the network node control circuit and coupled to the network node processor; and
wherein the network node processor is configured to execute a program code stored in the network node memory to:
receive a request message transmitted from a first network node to the second network node to request Carrier Aggregation to aggregate a cell controlled by the second network node to a UE, the request message including a Radio Network Temporary Identifier (RNTI) of a User Equipment (UE); and
transmit an accept message or a reject message from the second network node to the first network node to indicate whether to accept or reject Carrier Aggregation.

12. The communication system of claim 11, wherein the request message comprises at least one of:
power saving preference of the UE;
interference information of the UE for in device coexistence;
information related to a location of the UE;
a cause for Carrier Aggregation; or
one or more available values for the RNTI.

13. The communication system of claim 11, wherein the RNTI is used by the UE in a cell controlled by the first network node.

14. The communication system of claim 11, wherein the accept message comprises at least one of:
an indication of whether or not the second network node is a mobile relay;
congestion situation in the cell controlled by the second network node; or
a value for the RNTI.

15. The communication system of claim 11, wherein the RNTI is one of:
a Cell RNTI (C-RNTI);
a Transmit Power Control-Physical Uplink Control Channel RNTI (TPC-PUCCH-RNTI); or
a Transmit Power Control-Physical Uplink Shared Channel-RNTI (TPC-PUSCH-RNTI).

16. The communication system of claim 11, wherein the reject message comprises at least one of:
a reject cause set to unavailability of the RNTI if the RNTI is used by another UE in the cell controlled by the second network node;
one or more suggested values for the RNTI;
one or more available values for the RNTI;
a wait time to prohibit the request message;
congestion situation in the cell controlled by the second network node; or
a reject cause that the second network node is a mobile relay.

17. The communication system of claim 11, wherein the second network node transmits the reject message if the RNTI is used by another UE in the cell controlled by the second network node.

18. A communications system comprising:
a second network node comprising a network node control circuit, a network node processor installed in the network node control circuit, and a network node memory installed in the network node control circuit and coupled to the network node processor;
wherein the network node processor is configured to execute a program code stored in the network node memory to:
transmit a message from the second network node to a first network node; and
indicate with the message that one or more available values of a Radio Network Temporary Identifier (RNTI) corresponding to a cell controlled by the second network node.

19. The communication system of claim 18, wherein the second network node transmits the message to the first network node if requested by the first network node or the available values change compared with the available values previously transmitted to the first network node.

20. The communication system of claim 18, wherein the RNTI is one of:
a Cell RNTI (C-RNTI);
a Transmit Power Control-Physical Uplink Control Channel RNTI (TPC-PUCCH-RNTI); or
a Transmit Power Control-Physical Uplink Shared Channel-RNTI (TPC-PUSCH-RNTI).
